(19) United States
(12) Patent Application Publication
(10) Pub. No.: US 2025/0384710 A1
(43) Pub. Date: Dec. 18, 2025

(54) METHOD AND SYSTEM FOR POSE ESTIMATION USING EGOCENTRIC 3D POINT CLOUD DATA

(71) Applicant: Electronics and Telecommunications Research Institute, Daejeon (KR)

(72) Inventors: Seong Min BAEK, Daejeon (KR); Youn Hee GIL, Daejeon (KR); Ho Won KIM, Seoul (KR); Cho Rong YU, Daejeon (KR); Yong Ho LEE, Daejeon (KR); Sung Jin HONG, Daejeon (KR)

(73) Assignee: Electronics and Telecommunications Research Institute, Daejeon (KR)

(21) Appl. No.: 19/237,153

(22) Filed: Jun. 13, 2025

(30) Foreign Application Priority Data
Jun. 14, 2024 (KR) 10-2024-0077857
Jun. 12, 2025 (KR) 10-2025-0076870

(51) Int. Cl. G06V 40/10

(52) U.S. Cl. CPC G06V 40/10; G06T 2207/10028

(57) ABSTRACT

The present disclosure relates to a technique for real-time pose estimation of a user based on egocentric 3D point cloud data. According to one aspect of the present disclosure, a method is provided for performing real-time pose prediction through preprocessing of point cloud data, grid-based sampling, feature map transformation, and a lightweight neural network-based pose estimation model. Additionally, for training the pose estimation model, the present disclosure provides a method for automatically generating pose ground-truth data by aligning coordinate systems between a fixed external motion sensor and a depth sensor worn by the user, and for constructing a reliable training dataset through iterative refinement.

### CROSS-REFERENCE TO RELATED APPLICATION

This application is based on and claims priority to Korean Patent Application Nos. 10-2024-0077857, filed on Jun. 14, 2024, and 10-2025-0076870, filed on Jun. 12, 2025, the disclosures of which are hereby incorporated by reference in their entirety.

### TECHNICAL FIELD

The present disclosure relates to fields of computer vision and machine learning, and more specifically, relates to a method and a system for real-time human pose estimation using a lightweight neural network based on three-dimensional point cloud data acquired from an egocentric perspective.

### BACKGROUND

The following description merely provides background information related to the present embodiment and does not constitute prior art.

With recent advances in deep learning technology, there has been active research on estimating human joint positions and poses from RGB images. The existing technology is configured as follows. These conventional techniques typically take two-dimensional images (RGB images) captured from an external viewpoint as input, generate two-dimensional heatmaps representing the probability of joint presence, and then estimate three-dimensional joint positions based on the heatmaps.

Most of existing researches have been performed based on an outside-in approach, in which a user is observed through an external camera. However, recent research has focused on estimating the user's pose from an egocentric perspective. The egocentric perspective refers to a viewpoint in which sensors are attached near the user's head or face to observe their own movements or posture. This perspective can be implemented using wearable devices such as head-mounted displays (HMDs) or AR glasses, and offers the advantage of enabling more natural and precise user interaction in virtual reality (VR) or augmented reality (AR) environments. In particular, unlike the outside-in approach that relies on external cameras, the egocentric perspective imposes fewer constraints on user mobility and is better suited for applications that require real-time responsiveness.

However, RGB image-based approaches are susceptible to various factors such as lighting variations, clothing colors, and differences in users' body shapes. To compensate for these disturbances, a large amount of high-quality training data, that is, two-dimensional images paired with corresponding ground-truth joint position data, is required. In particular, in the egocentric perspective, a field of view is limited, and self-occlusion frequently occurs, making it even more challenging to collect adequate training data.

In addition, conventional deep learning-based models typically involve a complex architecture that first generates two-dimensional heatmaps and then reconstructs them into three-dimensional information. As a result, the high computational complexity makes real-time processing difficult.

### SUMMARY

The present disclosure aims to address the aforementioned problems by providing a technology capable of estimating a user's pose more accurately and efficiently in application domains that require real-time interaction, such as virtual reality (VR) and augmented reality (AR).

The present disclosure aims to overcome the limitations of conventional RGB-based pose estimation methods, which are sensitive to factors such as lighting, clothing colors, and occlusion, by providing a technology that enables stable pose estimation even under diverse environmental conditions.

The present disclosure aims to implement a real-time pose estimation system by effectively processing three-dimensional point cloud data acquired from an egocentric perspective.

The present disclosure aims to provide a method for automatically generating pose ground-truth data used for supervised learning of a pose estimation model and constructing a highly reliable training dataset through iterative refinement.

The problems to be solved by the present disclosure are not limited to those mentioned above, and other problems not explicitly described herein will be clearly understood by those skilled in the art from the following description.

At least one embodiment of the present disclosure provides a computer-implemented method for pose estimation, the method comprising: acquiring 3D point cloud data using a depth sensor worn by a user; removing background point data from the 3D point cloud data; sampling the 3D point cloud data based on a 2D grid configured according to the user's body dimensions; transforming the sampled data into a feature map; and estimating a pose of the user from the feature map using a neural network-based pose estimation model.

Another embodiment of the present disclosure provides a computer-implemented method for training a neural network-based pose estimation model, the method comprising: simultaneously acquiring 3D point cloud data using a depth sensor worn by a user and joint data using at least one motion sensor installed around the user; removing background point data from the 3D point cloud data; sampling the 3D point cloud data based on a 2D grid configured according to the user's body dimensions; generating pose ground-truth data by performing coordinate transformation to align a coordinate system of the joint data with a coordinate system of the sampled data; transforming the sampled data into a feature map; building a training dataset by associating the feature map with the corresponding ground-truth data; and training a neural network-based pose estimation model using the training dataset.

According to an embodiment of the present disclosure, by using three-dimensional point cloud data as input instead of RGB images, it is possible to reduce the influence of external factors such as lighting and clothing color, enabling accurate and robust pose estimation in diverse environments.

According to an embodiment of the present disclosure, an efficient pose estimation system capable of real-time processing may be implemented through preprocessing of three-dimensional point cloud data, grid-based sampling, feature map transformation, and a pose estimation model based on a lightweight neural network.

According to an embodiment of the present disclosure, pose ground-truth data may be automatically generated, and inaccurate training data may be iteratively removed and supplemented to build a high-quality training dataset. In this manner, prediction performance of a model may be improved.

The effects of the present disclosure are not limited to the effects mentioned above, and other effects not mentioned herein will be clearly understood by those skilled in the art, from the following description.

### BRIEF DESCRIPTION OF THE DRAWINGS

FIG. 1 is a conceptual diagram of a pose estimation system based on egocentric 3D point cloud data according to an embodiment of the present disclosure.

FIG. 2 is a schematic diagram illustrating a structure of a pose estimation model according to an embodiment of the present disclosure.

FIG. 3 is a flowchart illustrating a method for training the pose estimation model according to an embodiment of the present disclosure.

FIG. 4 is a conceptual diagram illustrating a ground surface detection method according to an embodiment of the present disclosure.

FIG. 5 is a diagram illustrating a grid structure for sampling 3D point cloud data according to an embodiment of the present disclosure.

FIG. 6 is a diagram illustrating surrounding points generated based on joint positions according to an embodiment of the present disclosure.

FIGS. 7A and 7B are diagrams exemplarily visualizing joint data and point cloud data before and after coordinate system alignment.

FIG. 8 is a flowchart illustrating a method for pose estimation based on the egocentric 3D point cloud data according to an embodiment of the present disclosure.

FIG. 9 is a diagram illustrating a process of refining pose estimation results using point cloud data and an avatar with fixed-length joints according to an embodiment of the present disclosure.

FIG. 10 is a block diagram schematically illustrating an exemplary computing device that may be used to implement the method described in the present disclosure.

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The description of the present disclosure to be presented below in conjunction with the accompanying drawings is directed to describe exemplary embodiments of the present disclosure and is not intended to represent the only embodiments in which the technical idea of the present disclosure may be practiced.

In the present specification, the term ‘neural network’ is used as a concept including an artificial neural network (ANN) or a deep neural network (DNN).

The present disclosure relates to a method and a system for real-time human pose estimation, based on 3D point cloud data acquired from an egocentric perspective.

A point cloud is acquired from a depth sensor mounted on the user's head, being oriented to face the user's full body. The point cloud is then structured based on a two-dimensional grid and transformed into a feature map that reflects the structural characteristics of the human body. The transformed feature map is used as input to a lightweight neural network-based pose estimation model, which estimates the user's pose in real time by outputting three-dimensional joint positions corresponding to the feature map.

To train the pose estimation model, joint data acquired from one or more fixed motion sensors installed around the user are aligned with the point cloud acquired from the depth sensor attached to the user. Through this alignment, pose ground-truth data corresponding to the point cloud are generated. Pairs of the generated ground truth data and the corresponding feature maps are used to construct a training dataset, which is then used to train the neural network-based pose estimation model.

Through this configuration, the present invention minimizes influence of external factors such as lighting variations, clothing colors, and occlusion which may affect conventional RGB-based pose estimation approaches, and enables accurate and fast pose estimation even with a lightweight neural network model.

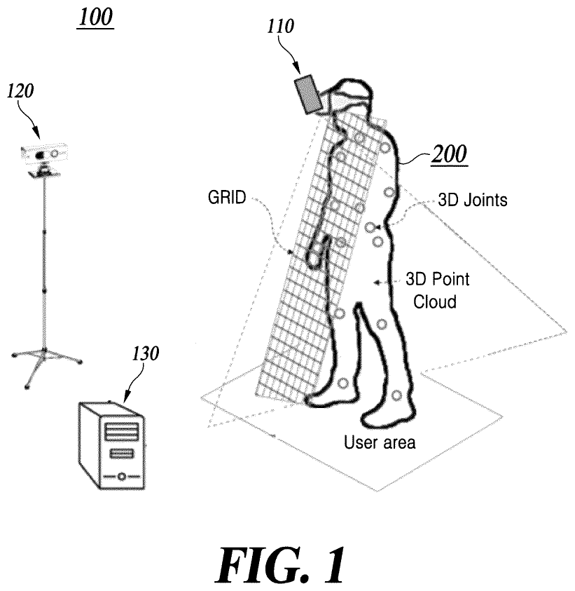

FIG. 1 is a conceptual diagram of a pose estimation system based on egocentric 3D point cloud data according to an embodiment of the present disclosure.

Referring to FIG. 1, a pose estimation system 100 according to an embodiment of the present disclosure includes a depth sensor 110 mounted on a head position of a user 200, one or more motion sensors 120 installed at fixed positions around the user, and a computing device 130 configured to process data collected from these sensors.

The depth sensor 110 is mounted on a wearable device worn on the head of the user 200, and is oriented to face the user's body. That is, the depth sensor 110 is attached to the head of the user, and configured to collect data from the egocentric perspective so that the user 200 is freely movable in a virtual or augmented reality environment. As a result, 3D point cloud data acquired from the egocentric perspective are generated in real time.

The motion sensor 120 is installed to collect joint position data based on a reference coordinate system outside the user, such as in an indoor environment, and is used only during training the pose estimation model. That is, the motion sensor 120 is used only for the purpose of generating the pose ground-truth data for building the training dataset. A motion tracking device such as Microsoft Kinect™ may be used as the motion sensor 120, and for the sake of data storage and computational efficiency, only joint data obtained from the sensor are used.

The computing device 130 receives the egocentric 3D point cloud data from the depth sensor 110, and estimates the user's pose in real time using a trained pose estimation model. To this end, the computing device 130 may perform a series of processes including preprocessing, sampling, feature map generation, and pose estimation. Additional refinement of the estimated pose may also be performed.

The computing device 130 also performs training of the pose estimation model. For this purpose, joint data obtained from the motion sensor 120 are aligned with point cloud data obtained from the depth sensor 110 to generate pose ground-truth data. These ground truth data are associated with corresponding feature maps to construct a training dataset, which is then used to train the pose estimation model.

The computing device 130 may also perform refining the training dataset, and may retrain the pose estimation model using the refined training dataset.

As shown in FIG. 1, the user 200 is positioned within a field of view (FOV) of the depth sensor 110. Among the acquired three-dimensional point cloud data, points corresponding to the ground or located outside a predefined spatial region (e.g., the user area) may be removed during a preprocessing stage.

The preprocessed point cloud is transformed into a 2D grid structure, where a width (W) and a height (H) of the grid are set based on the user's body dimensions.

For each cell in the grid, average coordinate values of the contained points are computed. Based on these average coordinate values, a feature map is generated for the entire grid by applying normalization and position-based weighting.

Here, the “feature map with position-based weights applied” refers to a feature map generated by applying relative importance or weights to each cell in the grid according to its position (X, Y, and Z coordinates), considering a body structure of the user and the placement of the depth sensor. For example, higher weights may be assigned to cells that are more likely to contain distal joints such as hands or feet, cells in occlusion-prone areas such as a lower body, or cells located toward the front of the user, i.e., closer to the depth sensor 110.

In the present disclosure, a pose of the user is directly estimated from 3D point cloud data by utilizing a lightweight neural network-based pose estimation model. To this end, the 3D point cloud data is transformed into the feature map through processes such as preprocessing and grid-based sampling, and the feature map is provided as input to the lightweight pose estimation model.

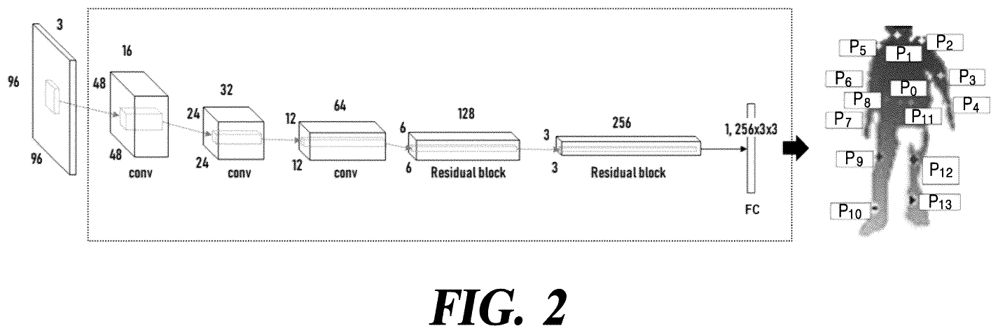

FIG. 2 is a schematic diagram illustrating a structure of the pose estimation model according to an embodiment of the present disclosure.

The pose estimation model is a neural network-based model designed to estimate 3D joint positions of the user, using as input the feature map generated based on the 3D point cloud data as described above. This model has a lightweight architecture suitable for real-time processing, and may include, for example, a total of eight layers including three convolutional layers, two residual blocks, and one fully connected layer.

In the present disclosure, point cloud data are used instead of an RGB image, and a compact feature map containing only user-related data is generated. As a result, accurate pose estimation can be achieved without the need for a deep network. This reduces computational load and improves both the processing efficiency and real-time performance of the neural network model.

As shown in FIG. 2, the pose estimation model may be configured to take as input a feature map, for example, of size 96×96×3, and to output 3D positions of 14 joints (Pₖ=(xₖ, yₖ, zₖ), where k denotes a joint index). Each output value corresponds to a 3D coordinate for one of the 14 joints, and the resulting joint positions collectively represent the full-body pose of the user.

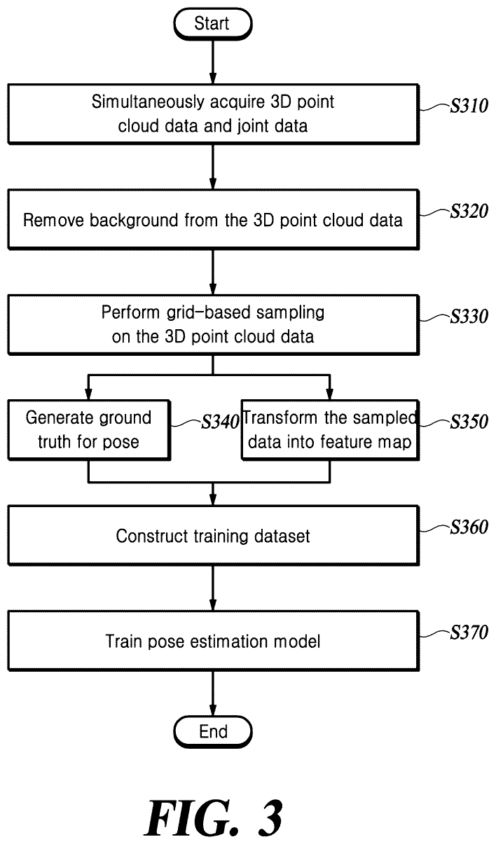

FIG. 3 is a flowchart of a method for training the pose estimation model according to an embodiment of the present disclosure.

The pose estimation model may be trained through supervised learning, in which case both input feature maps and output pose ground-truth data are required to construct the training dataset.

Referring to FIG. 3, the computing device 130 simultaneously acquires 3D point cloud data and joint data using the depth sensor 110 worn by the user 200 and at least one motion sensor 120 installed around the user (S310).

The computing device 130 transforms the 3D point cloud data to make it suitable for subsequent processing, analysis, and the like. For example, operations such as noise removal, normalization, resolution adjustment, and the like may be performed on the 3D point cloud data.

The computing device 130 removes background point data from the acquired 3D point cloud data (S320). Specifically, the computing device 130 searches for and removes points that correspond to the ground or are located outside a predefined user area in the acquired 3D point cloud data. This process removes unnecessary background information from the input point cloud data received from the depth sensor 110 and extracts only valid data directly related to the user, thereby improving the accuracy and processing efficiency of subsequent feature map generation and pose estimation.

Since the depth sensor 110 is attached to the user 200 and moves along with the user's motion, it is not possible to obtain ground information in advance, unlike the fixed motion sensor 120. Therefore, the computing device 130 has to detect a ground region in real time from the 3D point cloud data input at each frame.

Ground detection may be generally performed utilizing sampling-based plane estimation techniques such as the Random Sample Consensus (RANSAC) algorithm. However, the present disclosure proposes a more efficient ground detection method.

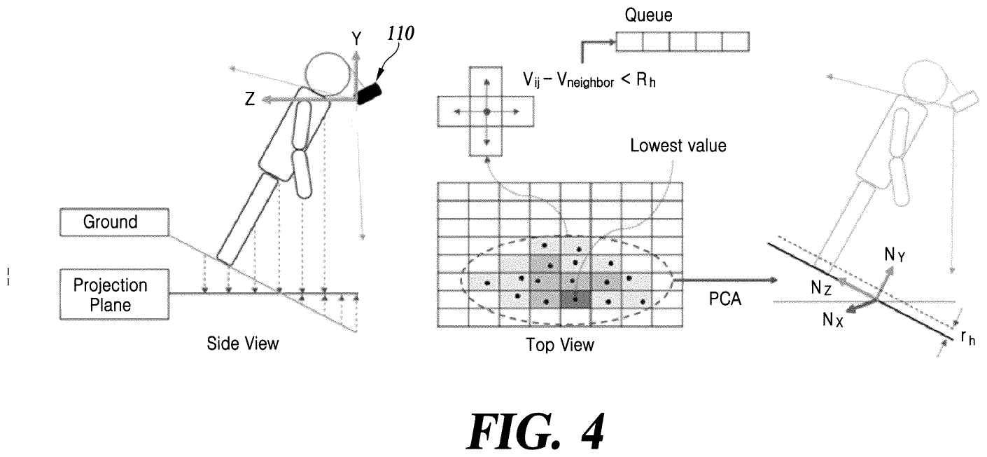

Referring to FIG. 4, the computing device 130 first performs a downward projection of the 3D point cloud along Y-axis of the depth sensor 110. On the resulting projection plane, a point with the lowest average height (indicated as “lowest value” in FIG. 4) is selected as an initial ground candidate and inserted into a queue.

Subsequently, neighboring points within a defined region around the initial point are examined, and those whose height difference (vᵢⱼ—v_{neighbor}) equal to or smaller than a threshold value Rₕ are added to the queue. This process is iteratively expanded to collect candidate ground points.

Principal component analysis (PCA) is then performed on the collected candidate ground points to determine the position and orientation (normal vector) of the ground surface. In subsequent frames, ground detection may be performed more efficiently based on this computed ground coordinate axis.

Once the ground is detected, points located within a certain height range rₕ with reference to a ground local Y-axis in the 3D point cloud are considered as the ground and removed. In addition, points located outside a predefined user area are also treated as background data and removed.

Through this preprocessing, errors and computational overhead which are caused by unnecessary information in the subsequent sampling and feature map generation stages may be reduced.

The computing device 130 samples the 3D point cloud data, based on the 2D grid configured according to the user's body dimensions (S330). The computing device 130 projects the 3D point cloud data onto the 2D grid and transforms it into sampled data. A size of the 2D grid is set to a predefined height H and width W, based on the user's body dimensions.

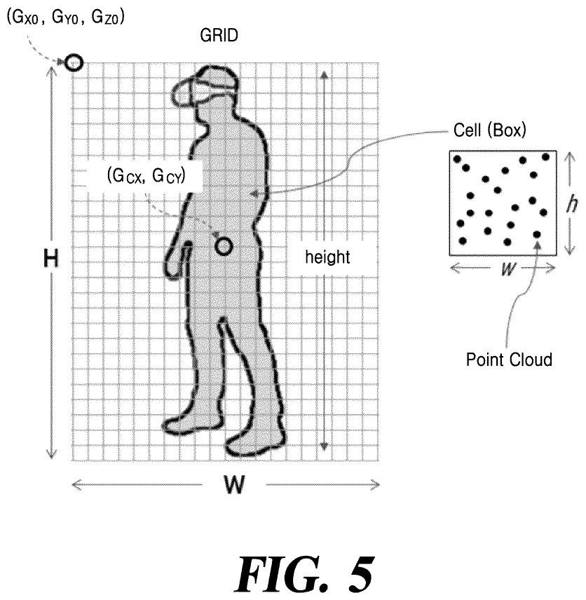

Referring to FIG. 5, the full body of the user 200 is included within the area of the 2D grid, and a size (H x W) of the 2D grid is set based on the user's body dimensions. In one embodiment of the present disclosure, since the input feature map size of the pose estimation model is 96×96×3, the grid consists of 96×96 cells, and the size (h, w) of each cell in the grid may be determined according to Equation 1.

$${box}_{h} = \frac{H}{96} , {box}_{w} = \frac{W}{96} \qquad ( Equation 1 )$$

Here, boxₕ denotes the height of each cell, box_{w} denotes the width of each cell, H denotes the height of the grid, and W denotes the width of the grid.

However, the input feature map size of the pose estimation model may vary depending on various modifications of the present disclosure, and accordingly, the number of cells constituting the grid and the size of each cell may be determined differently.

The 3D points of the user's point cloud are transformed with reference to an origin (Gₓ₀, G_{y0}, G_{z0}) of the grid, and projected onto the corresponding cells in the grid.

For each cell in the grid, the number of points contained within the cell is checked. If the number is smaller than a predetermined threshold, the points in the cell are considered noise and discarded. If the number is equal to or greater than the threshold, an average coordinate value of the points is calculated and used as a representative point. That is, the representative (or feature) value of each cell is defined as the average coordinate of the points within that cell.

This grid-based sampling approach provides the following advantages.

It allows the point cloud data to be transformed into a uniform structure suitable for input to a deep learning model. In addition, by calculating the average coordinate values on a per-cell basis, noise may be removed, and the amount of data may be effectively reduced. Furthermore, this approach improves the computational efficiency and accuracy of subsequent feature map generation and pose estimation.

The computing device 130 acquires the ground truth to be used as an input for training the pose estimation model. To this end, the computing device 130 performs a coordinate transformation to align the coordinate system of the joint data with that of the sampled data, thereby generating ground truth (S340). Here, the sampled data refers to the result of grid-based sampling of the 3D point cloud performed in step S330.

Since the attached depth sensor 110 moves with the user 200, it uses a coordinate system different from that of the fixed motion sensor 120. Accordingly, a coordinate alignment process is required to map the input data from the two sensors.

For this purpose, the computing device 130 augments the joint position data (P_{J}) acquired from the motion sensor 120 to generate a point cloud. Then, the computing device 130 performs registration between the generated point cloud and the grid-sampled 3D point cloud acquired from the depth sensor 110, computing a transformation matrix composed of a rotation matrix (R) and a translation matrix (T)

Here, the point cloud registration refers to finding a spatial transformation relationship between two point clouds having different coordinate systems. This transformation relationship may be represented by a transformation matrix or other forms, but is not limited thereto. Using the transformation matrix obtained through point cloud registration, the point clouds may be merged into a unified reference coordinate system. Algorithms such as Iterative Closest Point (ICP), Generalized ICP (GICP), and Normal Distributions Transform (NDT) may be used for the registration. Since both the joint data and the sampled point cloud maintain normalized structures and local spatial information, computational efficiency and registration accuracy may be simultaneously improved.

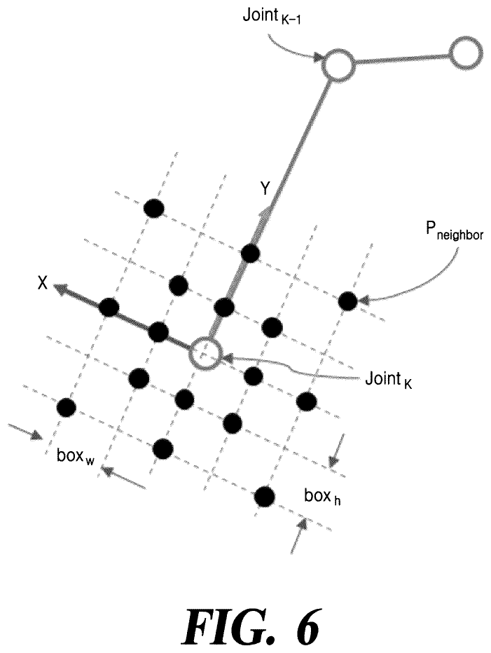

Referring to FIG. 6, a local coordinate system may be defined around the k-th joint position (Jointₖ) in the joint position data (P_{J}), and a set of virtual surrounding points (P_{Neighbor}) may be generated around the Jointₖ. The relative positions of these points may be determined based on a cell size (boxₕ and box,) used in grid-based sampling. For example, the distances between the virtual points may be set to 1× or 2× the cell size. This approach reduces the amount of data and computational burdens, while enhancing registration performance by ensuring structural similarity with the grid-sampled point cloud obtained from the attached sensor.

Specifically, the computing device 130 may select 14 joint positions (e.g., abdomen, shoulders, elbows, wrists, hips, knees, and ankles) from the joint position data (P_{J}) acquired from the motion sensor 120 for registration purposes. Using each parent-child joint pair (Joint_{K-1} and Joint_{K}), the local Y-axis may be defined along the vector between them, and the local X-axis may be calculated accordingly to establish a local X-Y plane. Based on this local coordinate system, a set of surrounding points (P_{Neighbor}) may be generated. This method of generating surrounding points based on joint data helps reduce the data size for easier storage and increases similarity with the sampled 3D point cloud, thereby accelerating ICP-based registration.

The computing device 130 applies the rotation matrix R and the translation matrix T, which are calculated as shown in Equation 2, to the joint position data P_{J} to generate a ground-truth data P_{GT} that are aligned with the coordinate system of the grid-sampled data. The resulting ground-truth data may be matched with the corresponding sampled feature map and used to construct a training dataset.

$${R}_{t} , {T}_{t} = {ICP}_{t} ( {P}_{Neighbor , t} \to {PC}_{user , t} ) \qquad ( Equation 2 )$$

$${P}_{GT , t} = {R}_{t} \cdot {P}_{J , t} + {T}_{t}$$

Here, the subscript t denotes a frame number, and PCᵤₛₑᵣ refers to data acquired by performing the grid-based sampling on the 3D point cloud acquired from the depth sensor 110.

In other words, for each frame, the computing device 130 performs point cloud registration to compute rotation matrix Rₜ and translation matrix Tₜ, and applies them to the joint position data P_{J,t} to generate a ground-truth data P_{GT,t}.

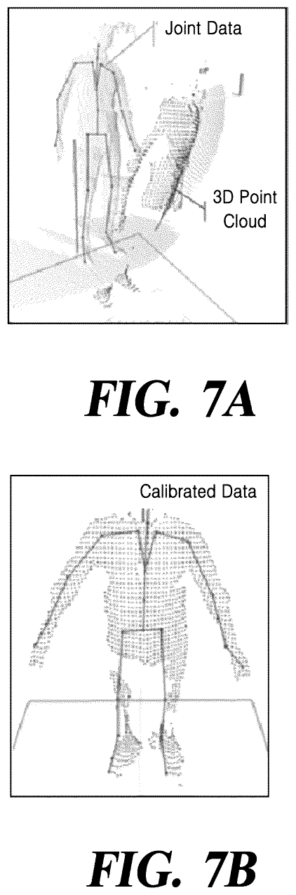

To aid understanding, FIG. 7A visualizes the joint data acquired from the fixed motion sensor 120 and the 3D point cloud data acquired from the depth sensor 110 for a specific frame, and FIG. 7B illustrates the result of registration between them.

The computing device 130 acquires the feature map to be used as an input for the pose estimation model. For this purpose, the computing device 130 transforms the sampled data into the feature map based on a result of the grid-based sampling performed in step S330 (S350).

The computing device 130 normalizes the position information of each cell in the sampled data, and applies position-based weighs to transform the normalized position information into the feature map.

Here, the “feature map with position-based weights applied” refers to the feature map generated by applying relative importance or a weight to each cell's position (X, Y, and Z coordinates) on the grid, considering a body structure of the user and the arrangement of the depth sensor. For example, higher weights may be applied to cells where distal joints such as hands or feet are likely to be located, cells in the lower body with a higher possibility of occlusion, or cells near the sensor at the front of the user.

For example, in the case of human pose estimation, the position data of the hands and feet are particularly important, and this positional characteristic is reflected when transforming the sampled data into a feature map. Referring again to FIG. 5, higher values are assigned to cells as their positions move farther to the left or right from the center point (G_{CX}, G_{CY}) of the grid, lower in the vertical direction, or closer to the depth sensor 110. This reflects a likelihood of occlusion and proximity to the sensor. The transformed feature map is ultimately used as input to the pose estimation model. This feature map transformation may be expressed as shown in Equation 3.

$${f}_{x} = \frac{abs ( {G}_{CX} - {b}_{x} )}{W / 2} , {f}_{y} = \frac{{b}_{y}}{H} , {f}_{z} = \frac{D - ( {b}_{z} \cdot N )}{D} \qquad ( Equation 3 )$$

Here, G_{CX} is an X-axis center coordinate of the grid, abs( ) is an absolute value function, bₓ, b_{y}, and b_{z} are the average coordinate values of the 3D points included in the cell. W, H, and D denote a height, a width, and a reference distance of the grid, respectively. N_{z} is a normal vector along the local Z-axis based on the ground.

That is, fₓ is a normalized value indicating the horizontal distance of a cell from the center, f_{y} is a Y-coordinate value normalized by the grid height H, and f_{z} is a normalized distance along the Z-axis relative to the sensor. In this case, f_{z} is calculated by subtracting the projected depth from D so that cells located closer to the depth sensor 110 are assigned higher values.

In this manner, by applying normalization and weighting based on the positional information of each cell, the sampled data can be effectively transformed into a feature map, which can then be efficiently utilized as input to the pose estimation model.

The computing device 130 associates each feature map with its corresponding ground-truth pose data to construct a training dataset (S360). Specifically, the computing device 130 forms pairs of feature maps and corresponding ground-truth pose data to build a training dataset for supervised learning of the pose estimation model.

The computing device 130 then trains the pose estimation model using the constructed training dataset (S370).

Meanwhile, the aforementioned ground-truth pose data are generated through a coordinate alignment process between the joint data and the grid-sampled 3D point cloud. Accordingly, some of the training data may be inaccurate due to errors that may occur during the registration process. In particular, accuracy of the transformation matrices R and T calculated by a point cloud registration algorithm may be affected by various environmental factors such as a structural difference between the joint data and the point cloud, noise, and occlusion. As a result, incorrectly aligned joint positions may lead to erroneous ground-truth data being included in the training dataset.

In order to remove such inaccurate training data and improve overall training performance, the computing device 130 may additionally perform a training dataset refinement procedure.

Specifically, the computing device 130 may use the trained pose estimation model to predict the pose for each entry in the existing training dataset, and calculate an error between the predicted joint positions and the corresponding ground-truth values. For example, if the error, which may be measured based on Euclidean distance, exceeds a predefined threshold (Err), the corresponding entry may be deemed inaccurate and removed from the training dataset. If necessary, new training data may also be generated by repeating the procedures of steps S310 to S350 and subsequently added to the dataset.

The pose estimation model may then be retrained based on the refined training dataset. Through this iterative training and refinement process, the quality of the training data can be continuously improved, thereby enhancing the prediction accuracy and reliability of the pose estimation model.

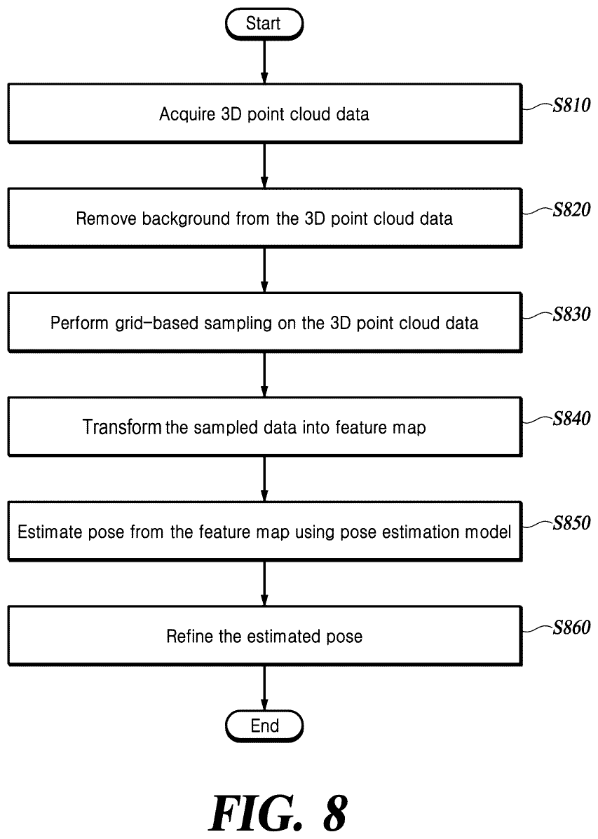

FIG. 8 is a flowchart illustrating a method for pose estimation based on the egocentric 3D point cloud data according to an embodiment of the present disclosure.

Referring to FIG. 8, the computing device 130 acquires the 3D point cloud data using the depth sensor 110 worn by user 200 (S810).

The computing device 130 removes the point data corresponding to the background from the acquired 3D point cloud data (S820). Specifically, the computing device 130 searches for and removes points that correspond to the ground or are located outside a predefined user area in the acquired 3D point cloud data. In this manner, the computing device 130 removes unnecessary background information from the input point cloud data received from the depth sensor 110 and extracts only valid data directly related to the user, thereby improving the accuracy and processing efficiency of subsequent feature map generation and pose estimation.

Since the detailed implementation of step S820 is the same as that of step S320 in the pose estimation model training procedure described above with reference to FIG. 3, a redundant explanation is omitted.

The computing device 130 samples the 3D point cloud data based on the 2D grid configured according to the user's body dimensions (S830). The computing device 130 performs a process of transforming the 3D point cloud data into the sampled data by projecting the 3D point cloud data onto the 2D grid. The size of the 2D grid is set to a predefined height H and width W, based on the user's body dimensions.

Since the detailed implementation of step S830 is the same as that of step S330 in the pose estimation model training procedure described above with reference to FIG. 3, a redundant explanation is omitted.

The computing device 130 transforms the sampled data into the feature map based on a result of the grid-based sampling performed in the process in S830 (S840). The computing device 130 normalizes position information of each cell for the sampled data and applies position-based weights to generate the feature map.

Since the detailed implementation of step S840 is the same as that of step S350 in the pose estimation model training procedure described above with reference to FIG. 3, a redundant explanation is omitted.

The computing device 130 estimates the pose of the user 200 from the feature map using the trained pose estimation model (S850).

After estimating the user's pose using the trained pose estimation model, the computing device 130 may perform an additional correction process on the estimated joint positions (S860). This is because the estimated 3D joint positions may not always maintain consistent distances or orientations between joints. For example, the joints may be irregularly spaced or connected in distorted forms that do not align with the human body structure. These issues arise because the pose estimation model is trained without explicit constraints on joint lengths.

To address this, the present disclosure proposes a technique for refining the estimated pose by leveraging both actual point cloud data and an avatar with fixed-length joints.

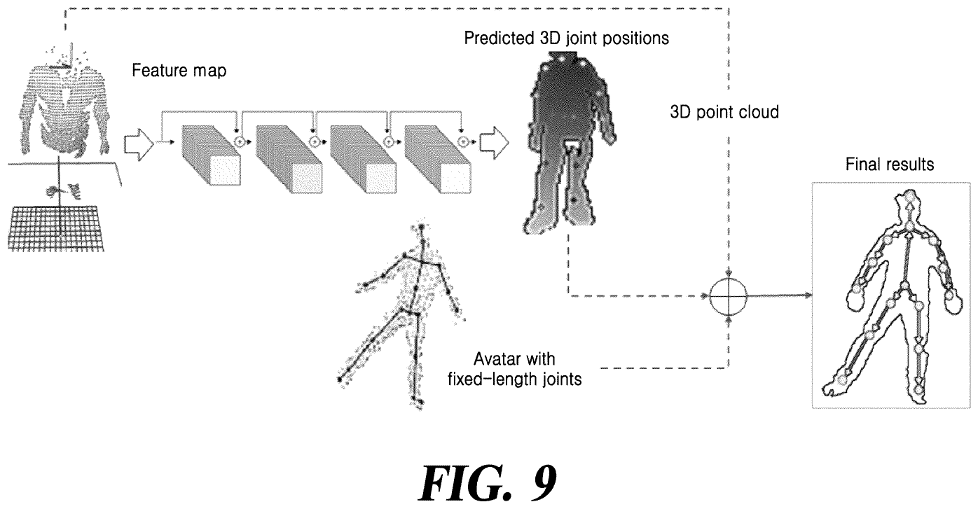

FIG. 9 is a diagram illustrating a process of refining pose estimation results using point cloud data and an avatar with fixed-length joints according to an embodiment of the present disclosure.

Based on the initially estimated joint positions, the computing device 130 first places virtual points at preset distances in the up, down, left, and right directions from each estimated joint position. Then, among these five points (the estimated joint and its four neighboring points), the computing device identifies the closest corresponding positions in the point cloud.

This method is a simplified version of the iterative closest point (ICP) algorithm, which can quickly converge to nearby point cloud locations in one to three iterations. As a result, the estimated joint positions can be refined more accurately toward the actual joint locations. If no nearby point cloud data are found due to occlusion, the initially estimated joint position is retained. An avatar with fixed-length joints is aligned with the estimated joint positions (e.g., using a least squares method), and the avatar's joint angles are adjusted using the actual joint positions obtained from the refined point cloud mapping. Since the adjustment is made by modifying joint angles, the lengths of the joints remain unchanged. Moreover, because the refinement is guided by actual point cloud data, the estimated joint positions can be corrected with greater accuracy.

The refined joint positions maintain consistent joint lengths and are adjusted to better match the user's actual body structure, thereby improving the reliability and accuracy of the final pose estimation. In particular, when certain joint estimates are unreliable due to a complex environment or missing point cloud data, the avatar structure can provide approximate corrections, contributing effectively to enhanced overall pose recognition performance.

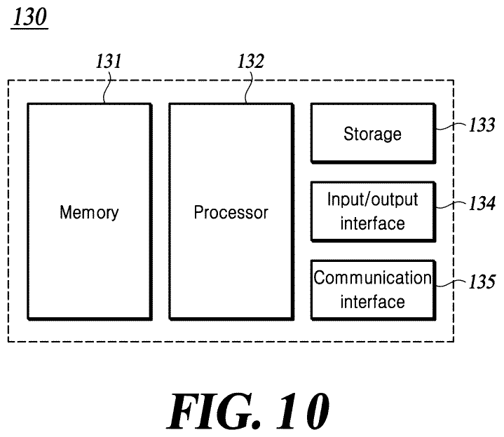

FIG. 10 is a block diagram schematically illustrating an exemplary computing device that may be used to implement the method described in the present disclosure.

The computing device 130 may include some or all of a memory 131, a processor 132, a storage 133, an input/output interface 134, and a communication interface 135. The computing device 130 may be not only a stationary computing device such as a desktop computer and a server, but also a mobile computing device such as a laptop computer and a smart phone. The computing device 130 may be implemented as any specialized hardware accelerator capable of efficiently processing operations for an artificial intelligence model. For example, the computing device 130 may include a graphic processing unit (GPU), a tensor processing unit (TPU), or a neural processing unit (NPU).

The memory 131 may store a program that causes the processor 132 to perform a method or an operation according to various embodiments of the present disclosure. For example, the program may include a plurality of commands executable by the processor 132, and the method or the operation may be performed by causing the processor 132 to execute the plurality of commands. The memory 131 may be a single memory or a plurality of memories. In this case, information required for performing the method or the operation according to various embodiments of the present disclosure may be stored in the single memory, or may be divided and stored in the plurality of memories. When the memory 131 includes the plurality of memories, the plurality of memories may be physically separated. The memory 131 may include at least one of a volatile memory and a nonvolatile memory. The volatile memory includes a static random access memory (SRAM) or a dynamic random access memory (DRAM), and the nonvolatile memory includes a flash memory.

The processor 132 may include at least one core capable of executing at least one command. The processor 132 may execute commands stored in the memory 131. The processor 132 may be a single processor or a plurality of processors.

The storage 133 maintains stored data even when power supplied to the computing device 130 is cut off. For example, the storage 133 may include the nonvolatile memory, and may include a storage medium such as a magnetic tape, an optical disk, and a magnetic disk. A program stored in the storage 133 may be loaded into the memory 131 before being executed by the processor 132. The storage 133 may store a file written in a program language, and a program generated from the file by a compiler or the like may be loaded into the memory 131. The storage 133 may store data to be processed by processor 132 and/or data processed by processor 132.

The input/output interface 134 may provide an interface with an input device such as a keyboard and a mouse and/or an output device such as a display device and a printer. A user may trigger execution of a program in the processor 132 through the input device and/or may check a processing result of the processor 132 through the output device.

The communication interface 135 may provide access to an external network. The computing device 130 may communicate with other devices via the communication interface 135.

In addition, in another embodiment, the computing device 130 may include fewer or more components than the components in FIG. 10. For example, the computing device 130 may be implemented to include at least a portion of the input/output devices described above, or may further include other components such as a database.

At least some of the components described in the exemplary embodiments of the present disclosure may be implemented as hardware elements including at least one or a combination of a digital signal processor (DSP), a processor, a controller, an application-specific IC (ASIC), a programmable logic device (FPGA, etc.), and other electronic devices. In addition, at least some of the functions or processes described in the exemplary embodiments may be implemented as software, and the software may be stored in a recording medium. At least some of the components, functions, and processes described in the exemplary embodiments of the present disclosure may be implemented through a combination of hardware and software.

The methods according to the exemplary embodiments of the present disclosure may be written as a program that can be executed on a computer, and may also be implemented in various recording mediums such as a magnetic storage medium, an optical read medium, and a digital storage medium.

Implementations of the various techniques described herein may be realized by digital electronic circuitry, or by computer hardware, firmware, software, or combinations thereof. Implementations may be made as a computer program tangibly embodied in a computer program product, i.e., an information carrier, e.g., machine-readable storage device (computer-readable medium) or a radio signal, for processing by, or controlling the operation of a data processing device, e.g., a programmable processor, a computer, or multiple computers. Computer programs, such as the computer program(s) described above, may be written in any form of programming language, including compiled or interpreted languages, and may be deployed in any form as a stand-alone program or as a module, component, subroutine, or other units suitable for use in a computing environment. The computer program may be processed on one computer or multiple computers at one site or distributed across multiple sites and developed to be interconnected through a communications network.

Processors suitable for processing computer programs include, by way of example, both general-purpose and special-purpose microprocessors, and any one or more processors of any type of digital computer. Typically, a processor will receive instructions and data from read-only memory or random access memory, or both. Elements of the computer may include at least one processor that executes instructions and one or more memory devices that store instructions and data. In general, the computer may include one or more mass storage devices that store data, such as magnetic disks, magneto-optical disks, or optical disks, or may be coupled to the mass storage devices to receive data therefrom and/or transmit data thereto. Information carriers suitable for embodying computer program instructions and data include, for example, semiconductor memory devices, magnetic mediums such as hard disks, floppy disks, and magnetic tapes, optical mediums such as CD-ROM (Compact Disk Read Only Memory), DVD (Digital Video Disk), magneto-optical mediums such as floptical disk, ROM (Read Only Memory), RAM (Random Access Memory), flash memory, EPROM (Erasable Programmable ROM), and EEPROM (Electrically Erasable Programmable ROM). The processor and memory may be supplemented by or included in special purpose logic circuitry.

The processor may execute an operating system and software applications executed on the operating system. In addition, the processor device may access, store, manipulate, process, and generate data in response to the execution of software. For ease of understanding, the processor device may be described as being used as a single processor device, but those skilled in the art will understand that the processor device may include a plurality of processing elements and/or a plurality of types of processing elements. For example, a processor device may include a plurality of processors or one processor, and one controller. Further, other processing configurations, such as parallel processors, are also possible.

In addition, a non-transitory computer-readable medium may be any available medium that can be accessed by a computer and may include both a computer storage medium and a transmission medium.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A computer-implemented method for pose estimation, the method comprising:
acquiring 3D point cloud data using a depth sensor worn by a user;
removing background point data from the 3D point cloud data;
sampling the 3D point cloud data based on a 2D grid configured according to the user's body dimensions;
transforming the sampled data into a feature map; and
estimating a pose of the user from the feature map using a neural network-based pose estimation model.

2. The method of claim 1, wherein the depth sensor is mounted on a wearable device worn on a head of the user and is oriented to face the user's body.

3. The method of claim 1, wherein removing the background point data includes:
searching for point data that correspond to a ground or are located outside a predefined spatial area in the 3D point cloud data, and
removing the searched point data from the 3D point cloud data.

4. The method of claim 1, wherein a width and a height of the 2D grid are set based on the user's body dimensions.

5. The method of claim 1, wherein sampling the 3D point cloud data includes:
projecting the 3D point cloud data onto the 2D grid;
calculating an average coordinate value of points included in each cell of the 2D grid; and
setting the calculated average coordinate value as a feature value of the corresponding cell.

6. The method of claim 5, wherein setting the calculated average coordinate value further includes:
removing the point data in the corresponding cell if a number of the points contained in each cell is smaller than a predetermined threshold.

7. The method of claim 5, wherein transforming the sampled data into the feature map includes:
normalizing a feature value of each cell of the 2D grid; and
applying position-based weights to the feature value of each cell of the 2D grid,
wherein the position-based weights are configured to increase:
as the cell is located farther to the left or right from a center point of the grid,
as the cell is located lower in a vertical direction of the grid, or
as the cell is located closer to a front side with respect to the depth sensor.

8. The method of claim 1, wherein the pose estimation model is trained to receive the feature map as an input and to output 3D joint position information representing a corresponding pose, and includes one or more convolutional layers, one or more residual blocks, and a fully connected layer.

9. The method of claim 1, further comprising:
refining the estimated pose using an avatar with fixed-length joints corresponding to the user and the 3D point cloud data.

10. A system for pose estimation, the system comprising:
one or more processors; and
a memory coupled with the one or more processors to be operable,
wherein the memory stores a command causing the one or more processors to perform operations in response to the command executed by the one or more processors, and the operations include:
acquiring 3D point cloud data using a depth sensor worn by a user;
removing background point data from the 3D point cloud data;
sampling the 3D point cloud data based on a 2D grid configured according to the user's body dimensions;
transforming the sampled data into a feature map; and
estimating a pose of the user from the feature map using a neural network-based pose estimation model.

11. A computer-implemented method for training a neural network-based pose estimation model, the method comprising:
simultaneously acquiring 3D point cloud data using a depth sensor worn by a user and joint data using at least one motion sensor installed around the user;
removing background point data from the 3D point cloud data;
sampling the 3D point cloud data based on a 2D grid configured according to the user's body dimensions;
generating pose ground-truth data by performing coordinate transformation to align a coordinate system of the joint data with a coordinate system of the sampled data;
transforming the sampled data into a feature map;
building a training dataset by associating the feature map with the corresponding ground-truth data; and
training a neural network-based pose estimation model using the training dataset.

12. The method of claim 11, wherein the depth sensor is mounted on a wearable device worn on a head of the user and is oriented to face the user's body, and the at least one motion sensor is fixedly installed at one or more positions around the user.

13. The method of claim 11, wherein removing the background point data includes:
searching for point data that correspond to a ground or are located outside a predefined spatial area in the 3D point cloud data, and
removing the searched point data from the 3D point cloud data.

14. The method of claim 11, wherein a width and a height of the 2D grid are set based on the user's body dimensions.

15. The method of claim 11, wherein sampling the 3D point cloud data includes:
projecting the 3D point cloud data onto the 2D grid;
calculating an average coordinate value of points included in each cell of the 2D grid; and
setting the calculated average coordinate value as a feature value of the corresponding cell.

16. The method of claim 15, wherein setting the calculated average coordinate value further includes:
removing point data in the corresponding cell, if a number of the points contained in each cell is smaller than a predetermined threshold.

17. The method of claim 15, wherein transforming the sampled data into the feature map includes:
normalizing a feature value of each cell of the 2D grid; and
applying position-based weights to the feature value of each cell of the 2D grid,
wherein the position-based weights are configured to increase:
as the cell is located farther to the left or right from a center point of the grid,
as the cell is located lower in a vertical direction of the grid, or
as the cell is located closer to a front side with respect to the depth sensor.

18. The method of claim 11, wherein the pose estimation model includes one or more convolutional layers, one or more residual blocks, and a fully connected layer.

19. The method of claim 11, further comprising refining the training dataset,
wherein refining the training dataset includes:
predicting joint data for each entry in the training dataset using the pose estimation model;
calculating an error between the predicted joint data and corresponding ground-truth data; and
removing the corresponding entry from the training dataset when the error exceeds a predefined threshold.

20. A system for training a neural network-based pose estimation model, the system comprising:
one or more processors; and
a memory coupled with the one or more processors to be operable,
wherein the memory stores a command causing the one or more processors to perform operations in response to the command executed by the one or more processors, and the operations include:
simultaneously acquiring 3D point cloud data using a depth sensor worn by a user and joint data using at least one motion sensor installed around the user;
removing background point data from the 3D point cloud data;
sampling the 3D point cloud data based on a 2D grid configured according to the user's body dimensions;
generating pose ground-truth data by performing coordinate transformation to align a coordinate system of the joint data with a coordinate system of the sampled data;
transforming the sampled data into a feature map;
building a training dataset by associating the feature map with the corresponding ground-truth data; and
training a neural network-based pose estimation model using the training dataset.
